(19) United States
(12) Patent Application Publication
(10) Pub. No.: US 2003/0195964 A1
(43) Pub. Date: Oct. 16, 2003

(54) Managing multicast sessions

(76) Inventor: Pravin D. Mane, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/121,015

(22) Filed: Apr. 10, 2002

(51) Int. Cl. G06F 15/173

(52) U.S. Cl. 709/227

(57) ABSTRACT

A method and apparatus to manage multicast communications are described.

### BACKGROUND

Multicast communication may refer to a network node sending a single message to a select group of recipients. Examples of a network node may comprise a computer, server or router. Many existing network nodes, however, may not be configured to send multicast communications. Further, managing a multicast session may consume resources from a network node that may be better allocated to other tasks. For this and other reasons, a need may exist to improve multicast communication.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention;

FIG. 2 is a block diagram of a system in accordance with one embodiment of the invention;

FIG. 3 is a first block flow diagram of operations performed by a multicast management module in accordance with one embodiment of the invention;

FIG. 4 is a second block flow diagram of operations performed by a multicast management module in accordance with one embodiment of the invention; and

FIG. 5 is a third block flow diagram of operations performed by a multicast management module in accordance with one embodiment of the invention.

### DETAILED DESCRIPTION

Embodiments of the invention may comprise a method and apparatus to manage multicast communication sessions. One embodiment of the invention may operate to convert requests for unicast connections to responses on multicast connections. The term “unicast” as used herein may refer to communicating a message from one network node to another network node. The term “multicast” as used herein may refer to communicating a message from one network node to multiple network nodes.

The efficient management of multicast sessions may be desirable when multiple clients request the same information, such as information from a popular website server. Rather than creating the typical unicast connection between each client and the server, the server may communicate the information using a multicast session. The clients may be instructed to join the multicast session to receive the information. By reducing the need for multiple unicast connections, the server may allocate system resources to other tasks that may potentially be more valuable. Further, conventional network nodes configured to perform unicast communications may take advantage of multicast connections without costly modifications to individual network nodes. As a result, users may realize better network performance and services.

In this detailed description, numerous specific details are set forth in order to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

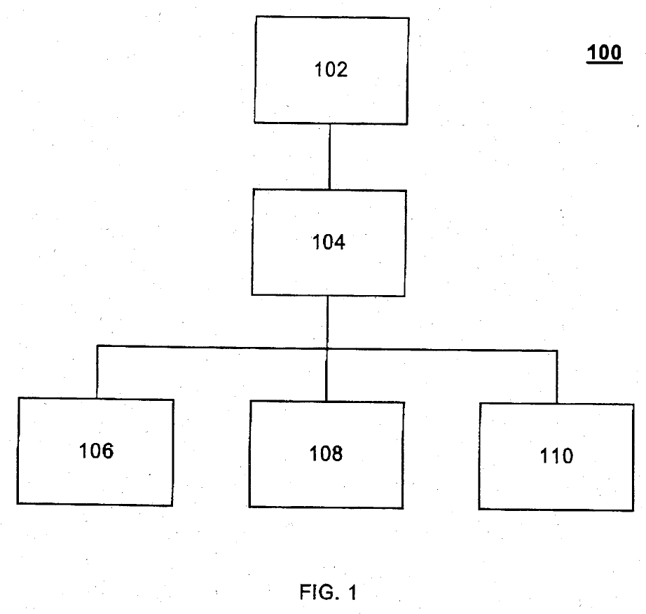

Referring now in detail to the drawings wherein like parts are designated by like reference numerals throughout, there is illustrated in FIG. 1 a system suitable for practicing one embodiment of the invention. FIG. 1 is a block diagram of a network 100. Network 100 may comprise network nodes 102, 104, 106, 108 and 110. Although only five network nodes are shown as part of network 100, it may be appreciated that network 100 may comprise any number of network nodes and still fall within the scope of the invention.

A network node may include a device capable of communicating with other devices over a network. Examples of a network node may include a computer, server, router, switch, bridge, network appliance, mobile telephone, personal digital assistant, and so forth.

The network nodes may communicate with one another using one or more communication protocols. For example, in one embodiment of the invention the network nodes may be capable of communicating information in accordance with the Transmission Control Protocol (TCP) as defined by the Internet Engineering Task Force (IETF) standard 7, Request For Comment (RFC) 793, adopted in September, 1981 (“TCP Specification”), the Internet Protocol (IP) as defined by the IETF standard 5, RFC 791, adopted in September, 1981 (“IP Specification”) (collectively referred to herein as the “TCP/IP Specification”), the Hyper Text Transfer Protocol (HTTP) Draft Standard 1.1, RFC 2616, adopted in June 1999 (“HTTP Specification”), and the User Datagram Protocol (UDP) Standard, RFC 0768, adopted in August 1980 (“UDP Specification), all of which are available from “www.ietf.org.” It can be appreciated, however, that the embodiments of the invention are not limited in this respect.

The network nodes may communicate over varying communications media, as indicated by the lines connecting the network nodes in network 100. Examples of communications media may include copper leads, twisted-pair wire, co-axial cable, optical fiber, radio frequencies and so forth.

In one embodiment of the invention, network node 102 may be a server capable of storing information. The information may comprise, for example, a combination of alphanumeric symbols, text, numbers, images, video, audio and other multimedia data. The information may be organized in any number of formats, such as a Hypertext Markup Language (HTML) file or Extensible Markup Language (XML) file.

In one embodiment of the invention, network nodes 106, 108 and 110 may be personal computers. These network nodes may be equipped with browser software for retrieving and displaying information in the form of, for example, HTML or XML files. Further, the browser software may be capable of creating a unicast connection to another network node, such as network node 104 or 102. The browser software may also be capable of joining a multicast connection given the appropriate control information, such as the multicast address. Further, the browser software may be configured to receive information over the multicast connection.

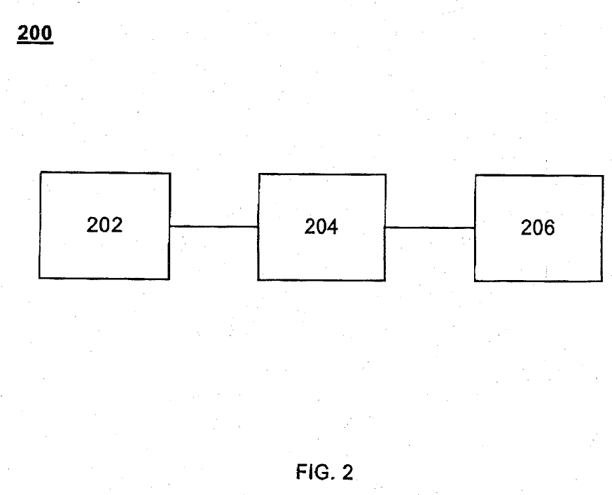

In one embodiment of the invention, network node 104 may be configured with a multicast management module (MMM). The MMM may manage multicast sessions for itself or other network nodes, such as network node 102, for example. The MMM may manage any type of multicast session in accordance with any number of multicast protocols, including multicast protocols associated with the IP Specification and UDP specification, as well as related specifications. The MMM may be discussed in more detail with respect to FIG. 2.

FIG. 2 is a block diagram of a multicast management module in accordance with one embodiment of the invention. FIG. 2 illustrates a MMM 200 that may be implemented, for example, as part of a network node such as network node 104. MMM 200 may be implemented as software executed by a processor, hardware circuits or structures, or a combination of both. The processor may be a general-purpose or dedicated processor, such as a processor from the family of processors made by Intel Corporation, Motorola Incorporated, Sun Microsystems Incorporated and others. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components.

MMM 200 may manage a multicast session for one or more network nodes. This may be particularly appropriate for network nodes configured to perform only conventional unicast communications. In one embodiment of the invention, MMM 200 may comprise a multicast converter 202, an information divider 204 and a multicast communicator 206. Multicast converter 202 may convert unicast requests for information into multicast sessions. Information divider 204 may divide the requested information into discrete portions or subsets of information. In one embodiment of the invention, information divider 205 may divide the requested information into discrete portions in accordance with one or more dividing algorithms appropriate for a particular type of information. Multicast communicator 206 may communicate the discrete portions in sequence over numerous cycles and to various network nodes over a multicast connection.

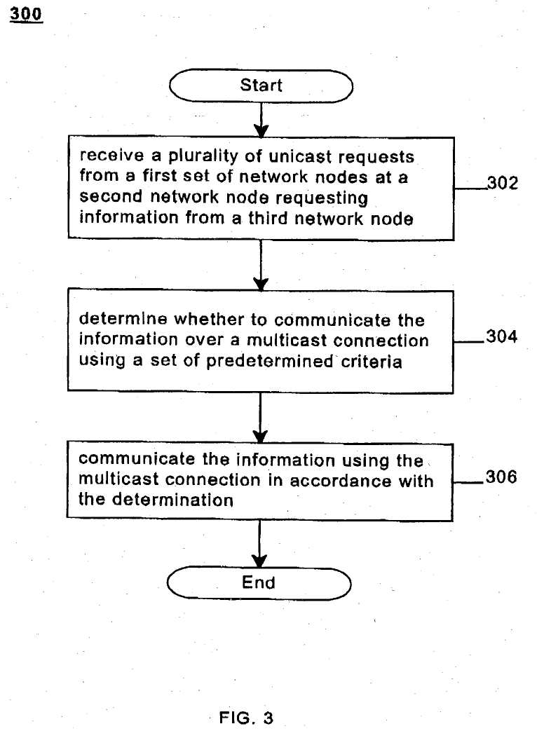

The operations of network 100 and MMM 200 may be further described with reference to FIGS. 3-5 and accompanying examples. Although FIGS. 3-5 presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 3 is a first block flow diagram of the programming logic performed by a multicast management module in accordance with one embodiment of the invention. In one embodiment of the invention, the MMM may refer to the software and/or hardware used to implement the functionality for managing a multicast session as described herein. In this embodiment of the invention, the MMM may be implemented as part of network node 104. It can be appreciated that this functionality, however, may be implemented by any device, or combination of devices, located anywhere in a communication network and still fall within the scope of the invention.

FIG. 3 may illustrate a programming logic to manage multicast sessions in accordance with one embodiment of the invention. A plurality of unicast requests may be received from a first set of network nodes at a second network node at block 302. The unicast requests may be for information from a third network node. In one embodiment of the invention, the unicast request is a TCP connection request between one of the first set of network nodes and the third network node. A determination may be made as to whether to communicate the information over a multicast connection using a set of predetermined criteria at block 304. At block 306, the information may be communicated using the multicast connection in accordance with the determination made at block 304. The multicast connection may be, for example, a UDP multicast connection.

In one embodiment of the invention, each of the first set of network nodes may send a termination request once the information is completely received by each node. The termination request may be, for example, an explicit message sent to the second network node acknowledging receipt of the requested information, or a general request to disconnect from the multicast connection, although the embodiments are not limited in this respect. Once termination messages have been received from each of the first set of network nodes, the multicast connection may be terminated.

The second network node may determine whether to communicate the information to the first set of network nodes over a multicast connection using a set of predetermined criteria. More particularly, a determination may be made regarding whether the information fits a set of predetermined criteria. The predetermined criteria may include, for example, whether the information is time-sensitive or popular as measured by the number of received requests. This type of information may also be referred to herein as a “hot page.” Examples of a hot page may be an XML or HTML file that is requested a relatively high number of times. If the information fits the set of predetermined criteria, a unicast connection may be created between one of the first network nodes and the second network node. The second network node may retrieve a multicast address for the multicast connection. The multicast address may be sent to the first network node, and the unicast connection between the first network node and the second network node may then be terminated.

In one embodiment of the invention, the information may be communicated to the first set of network nodes using a multicast connection. This may be accomplished by creating a unicast connection between the second network node and the third network node. The unicast connection may be, for example, a persistent TCP connection. The second network node may request the information from the third networking node using the unicast connection. The second network node may receive the information from the third network node over the unicast connection, and send the information to the first set of network nodes using the multicast connection.

In one embodiment of the invention, the second network node may send the information to the first set of network nodes over a multicast connection. This may be accomplished by dividing the information into discrete portions. The discrete portions may be sent in sequence from the second network node to the first set of network nodes until all of the information has been sent. The sending process may be repeated until a termination condition is met. A termination condition may be, for example, receiving a termination request message from each of the first set of network nodes. In this embodiment, the information may be received at the second node from the third node once, wherein the second node stores the information in memory. The unicast connection between the second and third network nodes may then be terminated. The second network node may perform cyclical transmissions of the information until a terminating condition is met. In one respect, the second node may perform as a proxy server for the third node thereby relieving the third node of some processing tasks.

In one embodiment of the invention, the unicast connection between the second network node and the third network node is persistent, that is, remains connected until instructed to terminate. In this embodiment, the second node makes repeated requests for the information from the third node on behalf of the first set of network nodes, receives the information, and performs multicast transmission of the information to the first set of network nodes. In one sense, the second network node operates as a conduit between the third network node and the first set of network nodes, with the segment between the second and third nodes being persistent unicast, and the segment between the second node and the first set of nodes being multicast.

In one embodiment of the invention, the information may be divided into discrete portions. This may be accomplished by determining a type for the information. The type may be based on the content of the information, such as whether the information is static or dynamic, whether the information contains audio or video data, and so forth. Once the type is established, a dividing algorithm associated with the type may be retrieved from an index, table or other data structure stored in memory. The information may then be divided using the associated dividing algorithm.

Any number or type of dividing algorithms may be implemented for MMM 200. For example, the dividing algorithm may separate the information into equal size pieces, and transmit accordingly. This may be particularly appropriate for static information. In another example, the dividing algorithm may separate the information according to objects within the information, such as text objects, graphic objects, table objects, embedded file objects, and so forth.

The dividing algorithm may also be modified according to other characteristics of the information. For example, the information may comprise an HTML or XML file having different classes of data, such as text, pictures, graphics, images, video and audio. MMM 200 may use certain HTML or XML tags to divide the data using HTML and XML data generators or parsers. Some information may have real time requirements, such as audio and video data. In this case, the dividing algorithm may account for bandwidth constraints. For example, some video standards such as the Motion Picture Group (MPEG) group of standards may use different frame types for data transmission (e.g., I frames, B frames and P frames). I frames are the most important frames, while B frames are derived from I frames, and P frames are derived from both I frames and B frames. So it is important that a receiver receives at least the I and P frames in real time. MMM 200 may employ a dividing algorithm that divides the data such that I frames are given priority transmission over other frames. This may potentially add redundancy, but may increase the probability that the receiver will get important data in real time. For other dynamic information such as real time stock updates, the dividing algorithm may account for the age of the data. For example, older data in the page can be sent less frequently than the dynamic data during cyclic multicast transmission. The dividing algorithm may provide time stamps for portions of the information, and communicate certain portions in accordance with the time stamp. It can be appreciated that these are merely some examples of the criteria for dividing information, and that any number of dividing algorithms may be used and still fall within the scope of the invention.

The operation of systems 100 and MMM 200, and the processing logic shown in FIG. 3, may be better understood by way of the following example. Assume that a user wants to read the latest news around the world. The user may access information from a CNN website. The user may type http://www.cnn.com in the web browser at his personal computer and get the latest news page on his desktop. But the user may not be the only person requesting the same page. There may be any number of users interested in the same data from CNN at the same time. The CNN server may send such pages almost all the time. And for continuously sending the same pages again and again to a different client each time, the server may have to spend many processing cycles in TCP connection establishment. This may lead to degraded performance of the server, lower connection rates and also lower response time to the client. Same case may be true for real time data requests like real time stock updates.

One embodiment of the invention may solve this problem using multicast communications. In multicast communication, a server may send one copy of the data to a group of clients and multicast capable routers in the network copies the data packets and forwards the copies on different links leading to all the clients that are interested in the data. This data distribution can be carried out in the network by creating a multicast routing tree using any one of the multicast routing protocols. A multicast routing protocol may be based on, for example, Core Based Trees (CBT). When servers are using multicast communication for data transmission, each server needs to keep track of the multicast group membership (i.e. number of clients involved in a multicast session). Also, clients need to know which multicast group address the server is transmitting data so that they attach to the proper multicast tree and listen on the group address for receiving multicast data.

These and other functions may be performed by the MMM, thereby reducing processor intensive tasks for the servers. The MMM may be implemented as part of a network node, such as a network appliance. The network appliance may perform other functions in addition to implementing the MMM, to consolidate operations and reduce costs. For example, the network appliance may perform load balancing, process Secure Socket Layer (SSL) transactions, and perform XML content-based switching. The network appliance may be placed between the unicast servers in a server farm and the outside world of clients. The MMM may then convert the unicast traffic between itself and the servers to multicast traffic for designated information or web pages.

For example, in one embodiment of the invention the MMM may receive a new request for information at a server farm. The MMM may perform load balancing to find out which is the best server for fulfilling the request. The MMM may be configured to process normal request using conventional methods and other requests, such as requests for hot pages.

If the MMM determines that the newly arrived request is for a hot page on the server, then it may choose a multicast address to transmit the page using cyclic multicast and informs the receiver to listen on that group address. If the request is the first request for a hot page, the MMM may establish a connection to the information server and request the data. When the data is sent by the information server, the MMM can covert the destination address to the Multicast address and may send that data to a proper multicast routing tree. If a new request arrives for the same hot page then the MMM may inform the new client to listen to the multicast group.

The cyclic multicast delivery can be achieved from existing unicast servers by the MMM making continuous requests to the server over the connection established between the MMM and the information server when the first connection had arrived. In one embodiment of the invention, the connection may be a persistent connection, for example. Since the MMM typically keep track of the client requests, the MMM is able to decide when to terminate the cyclic multicast and servers do not have to worry about the receiver group membership.

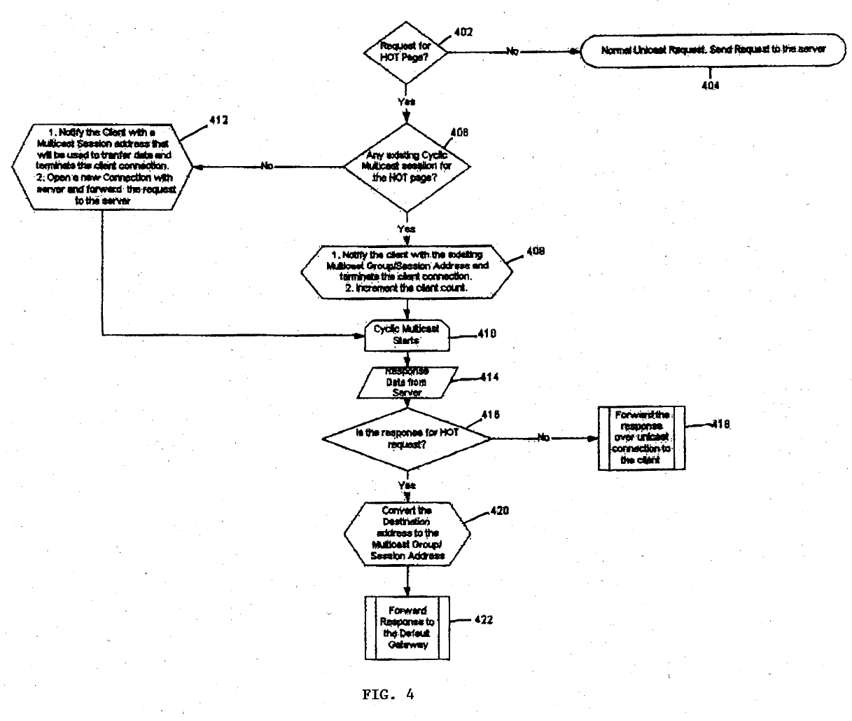

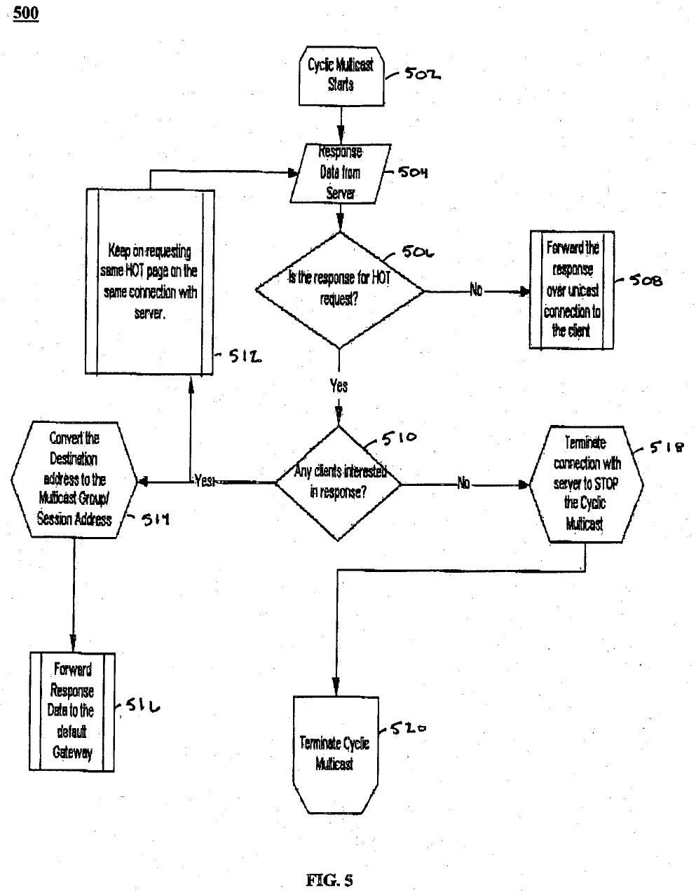

The example described above may be further illustrated using FIGS. 4 and 5. FIGS. 4 and 5 may provide possible implementations of one or more embodiments of the invention. It can be appreciated, however, that the embodiments of the invention are not limited to these examples.

FIG. 4 is a second block flow diagram of the programming logic performed by a multicast management module in accordance with one embodiment of the invention. FIG. 4 may illustrate an implementation for one or more embodiments of the invention. As shown in FIG. 4, the MMM may determine whether a new request is for a hot page that may be delivered using a cyclic multicast connection at block 402. If the request is not for a hot page then the request is forwarded to the information server directly. The information server may fulfill the request using a unicast connection at block 404. If the MMM determines that the request is for a hot page, however, the MMM determines whether there is an existing cyclic multicast connection for the hot page at block 406. If there is already a cyclic multicast connection for the hot page request, then the MMM may inform the client to listen on the multicast group address on which the information is being cyclically transmitted at block 408. If there is no such cyclic multicast connection for the hot page requested, then the MMM may assign a new multicast group address for that cyclic multicast connection and inform the client to listen on the assigned multicast group address at block 412. Meanwhile, the MMM may establish a connection with an appropriate information server and start requesting the page on that connection at block 410. The MMM may receive information from the information server at block 416. A determination may be made as to whether the information is the requested information at block 416. If the received information is not the requested information, the information may be forwarded to the client at block 418 using a unicast connection. If the received information is the requested information, however, the requested information may be modified for multicast communication at block 420. The modification may be implemented by, for example, converting the destination address for the requested information to the multicast group address. The modified requested information may be forwarded to the default gateway for communication at block 422.

To achieve cyclic delivery, the MMM may repeat the same hot page request on the same connection channel to the backend information server(s) as long as there are clients interested in the hot page. This may be discussed further using FIG. 5.

FIG. 5 is a third block flow diagram of the programming logic performed by a multicast management module in accordance with one embodiment of the invention. In a typical cyclic multicast session by the MMM, the MMM may open a connection with the server when a new session for cyclic multicast is required at block 502. When the connection with an appropriate information server is established, the MMM may request the same hot page from the information server repeatedly as long as there are clients interested in the hot page. This information about the client presence can be obtained by the MMM since it intercepts the client requests for the hot pages. This way, the MMM may keep track of the number of clients. When the MMM receives a response from the information server at block 504, the MMM may determine if the response is a request for a hot page at block 506. If the response is not for a hot request, the MMM may forward the response to the default gateway for communication to the client over a unicast connection at block 508. If the response is for hot page request, however, the MMM may determine the number of clients interested in the data at block 510. If there are clients interested at block 510, the MMM may continue to request the same hot page on the same connection with the information server on a periodic basis at block 512. Meanwhile, the MMM may convert the destination address of the response data to the multicast session group address at block 514. The source address for the response data may be converted to the address of the network node implementing the MMM. The response may then be forwarded to the default gateway for communication to the clients at block 516. Since the source and destination address pair typically identifies a multicast session, clients think that the response is from the information server. When the MMM determines that there are no more clients interested in the multicast session at block 510, the MMM may terminate the connection with the information server for the hot page at block 518, and may terminate the cyclic multicast session at block 520.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to manage a multicast session, comprising:
receiving a plurality of unicast requests from a first set of network nodes at a second network node requesting information from a third network node;
determining whether to communicate said information over a multicast connection using a set of predetermined criteria; and
communicating said information using said multicast connection in accordance with said determination.

2. The method of claim 1, further comprising:
receiving a termination request from one of said first set of network nodes once said information is completely received by said network node; and
terminating said multicast connection once all of said first set of network nodes completely receive said information.

3. The method of claim 1, wherein said unicast request is for a Transmission Control Protocol (TCP) connection between one of said first set of network nodes and said third network node.

4. The method of claim 1, wherein said determining comprises:
creating a unicast connection between one of said first network nodes and said second network node;
retrieving a multicast address for said multicast connection if said information fits said set of predetermined criteria;
sending said multicast address to said first network node; and
terminating said unicast connection between said one of said first network nodes and said second network node.

5. The method of claim 4, wherein said communicating comprises:
creating a unicast connection between said second network node and said third network node;
requesting said information from said third network node using said unicast connection;
receiving said information at said second network node over said unicast connection; and
sending said information from said second network node to said first set of network nodes using said multicast address.

6. The method of claim 5, wherein said unicast connection is a persistent Transmission Control Protocol (TCP) connection and said multicast connection is a User Datagram Protocol (UDP) connection.

7. The method of claim 5, wherein said sending comprises:
dividing said information into discrete portions;
sending said discrete portions in sequence from said second network node to said first set of network nodes until all of said information has been sent; and
repeating said sending said discrete portions in sequence until a termination condition is met.

8. The method of claim 7, wherein said termination condition comprises receiving a termination request from each of said first set of network nodes.

9. The method of claim 7, wherein said dividing comprises:
determining a type for said information;
retrieving a dividing algorithm associated with said type; and
dividing said information using said dividing algorithm.

10. A system to perform multicast, comprising:
a first network node to request information over a first unicast connection;
a second network node to retrieve said information over a second unicast connection;
a third network node to send said information to said second network node over said second unicast connection; and
wherein said second network node sends said information to said first network node over a multicast connection.

11. The system of claim 10, wherein said second network node comprises:
a multicast converter to convert said unicast request to a multicast connection;
an information divider to divide said information into discrete portions based on information type;
a multicast communicator to communicate said discrete portions in sequence over said multicast connection until a termination condition is met.

12. The system of claim 10, wherein said information divider determines a type for said information and divides said information using a dividing algorithm associated with said type.

13. An apparatus to manage multicast, comprising:
a multicast converter to convert a unicast request to a multicast connection;
an information divider to divide said information into discrete portions based on information type;
a multicast communicator to communicate said discrete portions in sequence over said multicast connection until a termination condition is met.

14. The apparatus of claim 13, wherein said information divider determines a type for said information and divides said information using a dividing algorithm associated with said type.

15. The apparatus of claim 13, wherein said termination condition comprises a request to terminate from one or more network nodes.

16. An article comprising:
a storage medium;
said storage medium including stored instructions that, when executed by a processor, result in managing a multicast session by receiving a plurality of unicast requests from a first set of network nodes at a second network node requesting information from a third network node, determining whether to communicate said information over a multicast connection using a set of predetermined criteria; and communicating said information using said multicast connection in accordance with said determination.

17. The article of claim 16, wherein the stored instructions, when executed by a processor, further result in receiving a termination request from one of said first set of network nodes once said information is completely received by said network node, and terminating said multicast connection once all of said first set of network nodes completely receive said information.

18. The article of claim 16, wherein the stored instructions, when executed by a processor, further result in said connecting by creating a unicast connection between one of said first network nodes and said second network node, retrieving a multicast address for said multicast connection if said information fits said set of predetermined criteria, sending said multicast address to said first network node, and terminating said unicast connection between said one of said first network nodes and said second network node.

19. The article of claim 18, wherein the stored instructions, when executed by a processor, further result in said communicating by creating a unicast connection between said second network node and said third network node, requesting said information from said third network node using said unicast connection, receiving said information at said second network node over said unicast connection, sending said information from said second network node to said first set of network nodes using said multicast address.

20. The article of claim 19, wherein the stored instructions, when executed by a processor, further result in said sending by dividing said information into discrete portions, sending said discrete portions in sequence from said second network node to said first set of network nodes until all of said information has been sent, and repeating said sending said discrete portions in sequence until a termination condition is met.

21. The article of claim 20, wherein the stored instructions, when executed by a processor, further result in said dividing by determining a type for said information, retrieving a dividing algorithm associated with said type, and dividing said information using said dividing algorithm.

22. The method of claim 5, wherein said unicast connection is persistent, and said requesting, receiving and sending of information are repeated until a termination condition is met.
